(19) United States
(12) Patent Application Publication
(10) Pub. No.: US 2023/0127064 A1
(43) Pub. Date: Apr. 27, 2023

(54) HUB WITH VOLTAGE DIVIDING FUNCTION

(71) Applicant: Cheng Uei Precision Industry Co., LTD., New Taipei City (TW)

(72) Inventor: CHIH-SHENG HO, New Taipei City (TW)

(21) Appl. No.: 17/871,735

(22) Filed: Jul. 22, 2022

(30) Foreign Application Priority Data
Oct. 22, 2021 (CN) 202122560096.5

(51) Int. Cl. H02J 7/00; H04N 21/4363; G06F 13/40

(52) U.S. Cl. CPC H02J 7/0013; H02J 7/0047; H04N 21/43635; G06F 13/4068; H02J 50/80

(57) ABSTRACT

A hub with voltage dividing function includes a control module, a detecting module connected with the control module, a voltage dividing module connected with the control module and the detecting module, a power supply port connected with the detecting module and the voltage dividing module, a main connecting port connected with the control module, the detecting module and the voltage dividing module, and an auxiliary connecting port connected with the control module. The detecting module detects a voltage value of the power supply port, and the voltage value of the power supply port is transmitted to the control module, the control module calculates an analysis signal according to the voltage value of the power supply port, a voltage value required by the main connecting port and a voltage value required by the auxiliary connecting port. The control module calculates a voltage dividing value.

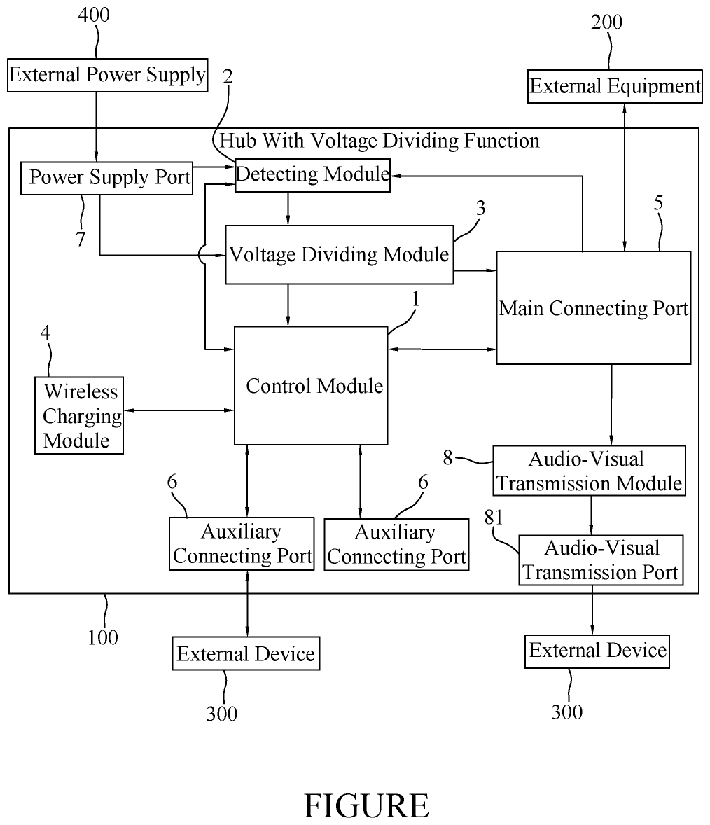

### CROSS-REFERENCE TO RELATED APPLICATION

The present application is based on, and claims priority from, China Patent Application No. 202122560096.5, filed Oct. 22, 2021, the disclosure of which is hereby incorporated by reference herein in its entirety.

### BACKGROUND OF THE INVENTION

### 1. Field of the Invention

The present invention generally relates to a hub, and more particularly to a hub with voltage dividing function.

### 2. The Related Art

Conventionally, a common hub is connected with an electronic equipment and an electronic device. The common hub is used to transmit data between the electronic equipment and the electronic device. The data is transmitted between the different electronic equipment and the different electronic devices by setting different transmission interfaces. The electronic equipment and the electronic device are driven by electricity, so when the common hub is used for transmitting the data between the electronic equipment and the electronic device, the electronic equipment and the electronic device must be connected to their respective chargers to make electric power provided for the electronic equipment and the electronic device, and an operation of electronic equipment and electronic device is maintained.

In order to save a need for the chargers, a connecting interface is connected to an existing hub, the connecting interface is able to be connected with an external power source, so that the external power source is led to the existing hub, and the electric power is supplied for the electronic equipment and the electronic device.

However, the existing hub uses a preset output voltage value of each output interface of the existing hub to divide an electric voltage, so each output interface has a single voltage output charging function to charge the electronic equipment or the electronic device, if an appropriate dividing voltage value for charging the electronic equipment and an appropriate dividing voltage value for charging the electronic device are inconsistent with original setting voltage values, a charging efficiency of the electronic equipment and a charging efficiency of the electronic device are affected.

Thus, it is necessary to provide a hub with voltage dividing function, appropriate dividing voltage values are provided for an external equipment and an external device by means of being able to analyze needed charging voltage values for the external equipment and the external device, so that a higher charging efficiency of the external equipment and a higher charging efficiency of the external device are achieved under an environment of a single external power supply.

### SUMMARY OF THE INVENTION

An object of the present invention is to provide a hub with voltage dividing function adapted for being connected with an object which is to be charged. The hub with voltage dividing function includes a control module, a detecting module connected with the control module, a voltage dividing module connected with the control module and the detecting module, a power supply port connected with the detecting module and the voltage dividing module, a main connecting port connected with the control module, the detecting module and the voltage dividing module, and an auxiliary connecting port connected with the control module. The object is connected with the main connecting port or the auxiliary connecting port. The detecting module detects a voltage value of the power supply port, and the voltage value of the power supply port is transmitted to the control module, the control module calculates an analysis signal according to the voltage value of the power supply port, a voltage value required by the main connecting port and a voltage value required by the auxiliary connecting port. The control module calculates a voltage dividing value based on the analysis signal. The voltage dividing value is appropriate to be provided to the object for charging, and the detecting module transmits the analysis signal to the voltage dividing module to divide the voltage value of the power supply port.

Another object of the present invention is to provide a hub with voltage dividing function adapted for being connected with an object which is to be charged. The hub with voltage dividing function includes a control module, a detecting module connected with the control module, a voltage dividing module connected with the control module and the detecting module, a power supply port connected with the detecting module and the voltage dividing module, a main connecting port connected with the control module, the detecting module and the voltage dividing module, and an auxiliary connecting port connected with the control module. The power supply port is connected with an external power supply. The main connecting port is connected with an external equipment. The auxiliary connecting port is connected to an external device. The detecting module detects a voltage value of the external power supply which is connected with the power supply port, and the voltage value of the external power supply is transmitted to the control module. The control module calculates an analysis signal according to the voltage value of the external power supply, a voltage value required by the external equipment which is connected with the main connecting port, and a voltage value required by the external device which is connected with the auxiliary connecting port. The control module calculates a voltage dividing value based on the analysis signal. The voltage dividing value is appropriate to be provided to the object for charging, the object is at least one of the external equipment and the external device, the detecting module transmits the analysis signal to the voltage dividing module to divide the voltage value of the external power supply which is connected with the power supply port.

Another object of the present invention is to provide a hub with voltage dividing function adapted for being connected with an object which is to be charged. The hub with voltage dividing function includes a control module, a detecting module connected with the control module, a voltage dividing module connected with the control module and the detecting module, a wireless charging module connected with the control module, a power supply port connected with the detecting module and the voltage dividing module, a main connecting port connected with the control module, the detecting module and the voltage dividing module, and an auxiliary connecting port connected with the control module. The detecting module detects whether the object which is to be charged is positioned to the wireless charging module. The power supply port is connected with an external power supply. The main connecting port is connected with an external equipment. The auxiliary connecting port is connected to an external device. The detecting module detects a voltage value of the external power supply which is connected with the power supply port, and the voltage value of the external power supply is transmitted to the control module. The control module calculates an analysis signal according to the voltage value of the external power supply, a voltage value required by the external equipment which is connected with the main connecting port, and a voltage value required by the external device which is connected with the auxiliary connecting port. The control module calculates a voltage dividing value based on the analysis signal. The voltage dividing value is appropriate to be provided to the object for charging, the object is at least one of the external equipment and the external device, the detecting module transmits the analysis signal to the voltage dividing module to divide the voltage value of the external power supply which is connected with the power supply port.

As described above, the hub with voltage dividing function detects the voltage value of the external power supply and the voltage values required by the external device and the external equipment, the control module analyzes the voltage value of the external power supply, and the voltage values required by the external device and the external equipment, and the control module calculates the voltage value of the external power supply, and the voltage values required by the external device and the external equipment, so appropriate dividing voltage values are provided for the external device and the external equipment through the voltage dividing module. As a result, a higher charging efficiency of the external equipment and a higher charging efficiency of the external device are achieved under an environment of the single external power supply.

### BRIEF DESCRIPTION OF THE DRAWINGS

The present invention will be apparent to those skilled in the art by reading the following description, with reference to the attached drawing, in which:

The FIGURE is a system block diagram of a hub with voltage dividing function according to a preferred embodiment of the present invention, wherein the hub with voltage dividing function is connected with an external equipment, an external device and an external power supply.

### DETAILED DESCRIPTION OF THE PREFERRED EMBODIMENT

With reference to the FIGURE, a hub with voltage dividing function 100 according to a preferred embodiment of the present invention is shown. The hub with voltage dividing function 100 is adapted for being connected with an object which is to be charged. The hub with voltage dividing function 100 includes a control module 1, a detecting module 2 connected with the control module 1, a voltage dividing module 3 connected with the control module 1 and the detecting module 2, a wireless charging module 4 connected with the control module 1, a main connecting port 5 connected with the control module 1, the detecting module 2 and the voltage dividing module 3, an auxiliary connecting port 6 connected with the control module 1, and a power supply port 7 connected with the detecting module 2 and the voltage dividing module 3. The object is connected with the main connecting port 5 or the auxiliary connecting port 6. In the preferred embodiment, the hub with voltage dividing function 100 includes two auxiliary connecting ports 6.

The control module 1 is connected with the detecting module 2, the voltage dividing module 3, the wireless charging module 4, the main connecting port 5 and the auxiliary connecting port 6.

The detecting module 2 is connected with the power supply port 7, the voltage dividing module 3 and the main connecting port 5.

The voltage dividing module 3 is connected with the power supply port 7 and the main connecting port 5. The voltage dividing module 3 is a metal-oxide-semiconductor field effect transistor (MOSFET) switch.

The main connecting port 5 is connected with an external equipment 200.

The auxiliary connecting port 6 is connected to an external device 300. The auxiliary connecting port 6 is a universal serial bus (USB) port.

The power supply port 7 is connected with an external power supply 400.

The control module 1 has a calculation function and a transmission function. A bidirectional transmission is realized between the external equipment 200 and the external device 300 through the main connecting port 5 and the auxiliary connecting port 6. Files and signals are bidirectionally transmitted between the external equipment 200 and the external device 300 through the main connecting port 5 and the auxiliary connecting port 6. The control module 1 bidirectionally communicates with the detecting module 2, so the detecting module 2 detects an appropriate voltage value of the external device 300 which is connected with the auxiliary connecting port 6 for charging, and the detecting module 2 detects whether the object which is to be charged is positioned to the wireless charging module 4. The object is at least one of the external equipment 200 and the external device 300.

The detecting module 2 detects a voltage value of the power supply port 7, and the voltage value of the power supply port 7 is transmitted to the control module 1, the control module 1 calculates an analysis signal according to the voltage value of the power supply port 7, a voltage value required by the main connecting port 5 and a voltage value required by the auxiliary connecting port 6. The detecting module 2 detects a voltage dividing signal. The control module 1 calculates a voltage dividing value based on the analysis signal. The voltage dividing value is appropriate to be provided to the object for charging, and the detecting module 2 transmits the analysis signal to the voltage dividing module 3 to divide the voltage value of the power supply port 7.

The detecting module 2 detects a voltage value of the external power supply 400 which is connected with the power supply port 7, and the voltage value of the external power supply 400 is transmitted to the control module 1. The control module 1 calculates the analysis signal according to the voltage value of the external power supply 400, a voltage value required by the external equipment 200 which is connected with the main connecting port 5, and the voltage value required by the external device 300 which is connected with the auxiliary connecting port 6. The control module 1 calculates the voltage dividing value based on the analysis signal. The voltage dividing value is appropriate to be provided to the object for charging. The detecting module 2 transmits the analysis signal to the voltage dividing module 3 to divide the voltage value of the external power supply 400 which is connected with the power supply port 7. The control module 1 analyzes the voltage value of the external power supply 400, and the voltage values required by the external device 300 and the external equipment 200, and the control module 1 calculates the voltage value of the external power supply 400, and the voltage values required by the external device 300 and the external equipment 200, so appropriate dividing voltage values are provided for the external device 300 and the external equipment 200 through the voltage dividing module 3.

The voltage dividing module 3 has a function of dividing the voltage value of the external power supply 400. The voltage value of the external power supply 400 is divided according to the analysis signal provided from the detecting module 2 to provide an appropriate current and an appropriate voltage to the external equipment 200 which is connected with the main connecting port 5, and the external device 300 which is connected with the auxiliary connecting port 6.

When the main connecting port 5 is connected with the external equipment 200, the auxiliary connecting port 6 is connected with the external device 300, and the power supply port 7 is without being connected to the external power supply 400, the external equipment 200 performs a signal transmission with the external device 300. The signal transmission from the external equipment 200 to the external device 300 is performed via the main connecting port 5, the control module 1 and the auxiliary connecting port 6 in sequence. In this case, the external equipment 200 has a host function, and the external device 300 has a client function.

When the main connecting port 5 is connected with the external equipment 200, the auxiliary connecting port 6 is without being connected to the external device 300, and the power supply port 7 is connected with the external power supply 400, the main connecting port 5 sends an electrical signal to the detecting module 2, so that the detecting module 2 detects that the main connecting port 5 is connected with the external equipment 200. In the meanwhile, the main connecting port 5 sends another electrical signal to the control module 1, so that the control module 1 recognizes electric power required by the external device 300 which is connected to the main connecting port 5.

When the external power supply 400 is connected with the power supply port 7, the power supply port 7 sends the electrical signal to the detecting module 2, so that the detecting module 2 detects the voltage value of the external power supply 400 currently. Then the detecting module 2 transmits the voltage value of the external power supply 400 to the control module 1. The control module 1 confirms that the auxiliary connecting port 6 is without being connected to any external device 300 currently. Calculate a comparison between the voltage value of the external power supply 400 and electric power required by the external equipment 200 to obtain the analysis signal which is appropriate to provide the voltage value for the external equipment 200. Then the analysis signal is sent to the detecting module 2, the detecting module 2 transmits the analysis signal to the voltage dividing module 3, and the detecting module 2 sends a voltage dividing command which is based on the analysis signal to the voltage dividing module 3. At the same time, the power supply port 7 transmits the current of the external power supply 400 to the voltage dividing module 3, and according to the analysis signal, the voltage dividing module 3 transmits the electric power which is appropriate to be received by the external equipment 200 to the external equipment 200 via the main connecting port 5.

When the main connecting port 5 is without being connected to the external equipment 200, the auxiliary connecting port 6 is connected with the external device 300, and the power supply port 7 is connected with the external power supply 400, the power supply port 7 sends the electrical signal to the detecting module 2, so that the detecting module 2 detects the voltage value of the external power supply 400 currently. Then the detecting module 2 transmits the detected voltage value of the external power supply 400 to the control module 1. The control module 1 confirms that the auxiliary connecting port 6 is connected with the external device 300 currently, and the control module 1 detects the electric power required by the external device 300, and then calculate a comparison between the voltage value of the external power supply 400 and the electric power required by the external device 300 to obtain the analysis signal which is appropriate to provide the voltage value for the external device 300. Subsequently, the analysis signal is transmitted to the detecting module 2, and the detecting module 2 transmits the analysis signal to the voltage dividing module 3. The detecting module 2 sends the voltage dividing command which is based on the analysis signal to the voltage dividing module 3. At the same time, the power supply port 7 transmits the current of the external power supply 400 to the voltage dividing module 3. The voltage dividing module 3 transmits the current to the control module 1 according to the analysis signal. Then the control module 1 divides the appropriate voltage value of the external device 300 which is connected with the auxiliary connecting port 6. The control module 1 provides an appropriate amount of the current for the external device 300 according to the appropriate voltage value of the external device 300 which is connected with the auxiliary connecting port 6.

When the main connecting port 5 is connected with the external equipment 200, the auxiliary connecting port 6 is connected with the external device 300, and the power supply port 7 is connected with the external power supply 400, the main connecting port 5 transmits the electrical signal to the detecting module 2, so that the detecting module 2 detects that the main connecting port 5 is connected with the external equipment 200. When the external power supply 400 is connected with the power supply port 7, the power supply port 7 transmits the electrical signal to the detecting module 2, so that the detecting module 2 detects the voltage value of the external power supply 400 at present. Then the detecting module 2 transmits the detected voltage value of the external power supply 400 to the control module 1.

The control module 1 confirms that the auxiliary connecting port 6 is connected with the external device 300, and the control module 1 detects the electric power required by the external device 300. Calculate the comparison between the voltage value of the external power supply 400 and the electric power required by the external device 300 to obtain the analysis signal which is appropriate to provide the voltage value for the external device 300. Subsequently, the analysis signal is transmitted to the detecting module 2, and the detecting module 2 transmits the analysis signal to the voltage dividing module 3. The detecting module 2 sends the voltage dividing command which is based on the analysis signal to the voltage dividing module 3. At the same time, the power supply port 7 transmits the current of the external power supply 400 to the voltage dividing module 3. The voltage dividing module 3 transmits the current to the control module 1 according to the analysis signal, so that the appropriate amount of the current is provided for the external device 300. The voltage dividing module 3 transmits the remaining current in the external power supply 400 to the main connecting port 5 to provide the remaining current to the external equipment 200. In this way, the external equipment 200 and the external device 300 are appropriately charged simultaneously by dividing the voltage value of the external power supply 400.

When the external device 300 is placed on the wireless charging module 4, the wireless charging module 4 transmits a transmission signal to the control module 1. The control module 1 recalculates the analysis signal for dividing the voltage value of the external power supply 400, and the control module 1 transmits the recalculated analysis signal to the detecting module 2 in real time. Then the detecting module 2 transmits the recalculated analysis signal to the voltage dividing module 3 to update a voltage dividing state, and the control module 1 supplies an electricity to the wireless charging module 4 to wirelessly charge the external device 300.

In this preferred embodiment, the hub with voltage dividing function 100 further includes an audio-visual transmission module 8. The audio-visual transmission module 8 is connected with the main connecting port 5. The audio-visual transmission module 8 is connected with an audio-visual transmission port 81. The audio-visual transmission module 8 includes the audio-visual transmission port 81. The audio-visual transmission module 8 has a function of transmitting video signals and audio signals. Specifically, the audio-visual transmission port 81 is a high definition multimedia interface (HDMI) port. The audio-visual transmission port 81 is connected with another external device 300 with an audio-visual function. The external equipment 200, the main connecting port 5, the audio-visual transmission module 8, the audio-visual transmission port 81 and the external device 300 are connected in sequence. The external equipment 200 transmits the video signals and the audio signals to the external device 300 with the audio-visual function through the main connecting port 5, the audio-visual transmission module 8 and the audio-visual transmission port 81.

As described above, the hub with voltage dividing function 100 detects the voltage value of the external power supply 400 and the voltage values required by the external device 300 and the external equipment 200, the control module 1 analyzes the voltage value of the external power supply 400, and the voltage values required by the external device 300 and the external equipment 200, and the control module 1 calculates the voltage value of the external power supply 400, and the voltage values required by the external device 300 and the external equipment 200, so the appropriate dividing voltage values are provided for the external device 300 and the external equipment 200 through the voltage dividing module 3. As a result, a higher charging efficiency of the external equipment 200 and a higher charging efficiency of the external device 300 are achieved under an environment of the single external power supply 400.

What is claimed is:

1. A hub with voltage dividing function adapted for being connected with an object which is to be charged, comprising:
a control module;
a detecting module connected with the control module;
a voltage dividing module connected with the control module and the detecting module;
a power supply port connected with the detecting module and the voltage dividing module;
a main connecting port connected with the control module, the detecting module and the voltage dividing module; and
an auxiliary connecting port connected with the control module;
wherein the object is connected with the main connecting port or the auxiliary connecting port, the detecting module detects a voltage value of the power supply port, and the voltage value of the power supply port is transmitted to the control module, the control module calculates an analysis signal according to the voltage value of the power supply port, a voltage value required by the main connecting port and a voltage value required by the auxiliary connecting port, the control module calculates a voltage dividing value based on the analysis signal, the voltage dividing value is appropriate to be provided to the object for charging, and the detecting module transmits the analysis signal to the voltage dividing module to divide the voltage value of the power supply port.

2. The hub with voltage dividing function as claimed in claim 1, further comprising a wireless charging module, the wireless charging module being connected with the control module, the detecting module detecting whether the object which is to be charged is positioned to the wireless charging module.

3. The hub with voltage dividing function as claimed in claim 1, wherein the power supply port is connected with an external power supply, the main connecting port is connected with an external equipment, the auxiliary connecting port is connected to an external device, the object is at least one of the external equipment and the external device.

4. The hub with voltage dividing function as claimed in claim 3, wherein a bidirectional transmission is realized between the external equipment and the external device through the main connecting port and the auxiliary connecting port.

5. The hub with voltage dividing function as claimed in claim 3, wherein the control module bidirectionally communicates with the detecting module, so the detecting module detects an appropriate voltage value of the external device which is connected with the auxiliary connecting port for charging.

6. The hub with voltage dividing function as claimed in claim 3, further comprising an audio-visual transmission module, the audio-visual transmission module being connected with the main connecting port, the audio-visual transmission module being connected with an audio-visual transmission port, the audio-visual transmission port being connected with another external device with an audio-visual function.

7. The hub with voltage dividing function as claimed in claim 6, wherein the external equipment, the main connecting port, the audio-visual transmission module, the audio-visual transmission port and the external device are connected in sequence, the external equipment transmits video signals and audio signals to the external device with the audio-visual function through the main connecting port, the audio-visual transmission module and the audio-visual transmission port.

8. The hub with voltage dividing function as claimed in claim 6, wherein the audio-visual transmission port is a high definition multimedia interface port.

9. The hub with voltage dividing function as claimed in claim 1, wherein the auxiliary connecting port is a universal serial bus port.

10. The hub with voltage dividing function as claimed in claim 1, wherein the voltage dividing module is a metal-oxide-semiconductor field effect transistor switch.

11. The hub with voltage dividing function as claimed in claim 1, wherein the control module has a calculation function and a transmission function.

12. A hub with voltage dividing function adapted for being connected with an object which is to be charged, comprising:
a control module;
a detecting module connected with the control module;
a voltage dividing module connected with the control module and the detecting module;
a power supply port connected with the detecting module and the voltage dividing module, the power supply port being connected with an external power supply;
a main connecting port connected with the control module, the detecting module and the voltage dividing module, the main connecting port being connected with an external equipment; and
an auxiliary connecting port connected with the control module, the auxiliary connecting port being connected to an external device;
wherein the detecting module detects a voltage value of the external power supply which is connected with the power supply port, and the voltage value of the external power supply is transmitted to the control module, the control module calculates an analysis signal according to the voltage value of the external power supply, a voltage value required by the external equipment which is connected with the main connecting port, and a voltage value required by the external device which is connected with the auxiliary connecting port, the control module calculates a voltage dividing value based on the analysis signal, the voltage dividing value is appropriate to be provided to the object for charging, the object is at least one of the external equipment and the external device, the detecting module transmits the analysis signal to the voltage dividing module to divide the voltage value of the external power supply which is connected with the power supply port.

13. A hub with voltage dividing function adapted for being connected with an object which is to be charged, comprising:
a control module;
a detecting module connected with the control module;
a voltage dividing module connected with the control module and the detecting module;
a wireless charging module connected with the control module, the detecting module detecting whether the object which is to be charged is positioned to the wireless charging module;
a power supply port connected with the detecting module and the voltage dividing module, the power supply port being connected with an external power supply;
a main connecting port connected with the control module, the detecting module and the voltage dividing module, the main connecting port being connected with an external equipment; and
an auxiliary connecting port connected with the control module, the auxiliary connecting port being connected to an external device;
wherein the detecting module detects a voltage value of the external power supply which is connected with the power supply port, and the voltage value of the external power supply is transmitted to the control module, the control module calculates an analysis signal according to the voltage value of the external power supply, a voltage value required by the external equipment which is connected with the main connecting port, and a voltage value required by the external device which is connected with the auxiliary connecting port, the control module calculates a voltage dividing value based on the analysis signal, the voltage dividing value is appropriate to be provided to the object for charging, the object is at least one of the external equipment and the external device, the detecting module transmits the analysis signal to the voltage dividing module to divide the voltage value of the external power supply which is connected with the power supply port.
